(19) United States
(12) Patent Application Publication
(10) Pub. No.: US 2009/0114059 A1
(43) Pub. Date: May 7, 2009

(54) CURVED SURFACE ACTUATING MECHANISM AND DOLL USING THE SAME

(75) Inventors: Chia-Chun CHU, Tainan City (TW); Ching-Shuan Chiu, Taichung City (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 12/061,057

(22) Filed: Apr. 2, 2008

(30) Foreign Application Priority Data
Nov. 1, 2007 (TW) 096141127

(51) Int. Cl. F16H 37/06; A63H 3/40

(52) U.S. Cl. 74/661; 74/424.6; 446/97

(57) ABSTRACT

A curved surface actuating mechanism suitable for controlling motions of eyelids for a doll is provided, which includes a main shaft, a first drive unit, a second drive unit, a third drive unit, a sleeve, and a curved surface. The main shaft is a fixed shaft. A first drive wheel of the first drive unit is fitted on the main shaft and driven to rotate by a first driving member. A second drive wheel of the second drive unit is fitted on the main shaft and driven to rotate by a second driving member. The sleeve is fitted on the main shaft and has a vertical split shaft. A third drive wheel of the third drive unit is fitted on the vertical split shaft, and meanwhile engaged with the first and the second drive wheels. The curved surface has a link lever fixed to the third drive wheel.

### BACKGROUND OF THE INVENTION

1. Field of the Invention

The present invention relates to a curved surface actuating mechanism, and more particularly to an actuating mechanism, applicable for opening and closing or controlling the rotating angle of eyelids for a doll.

2. Description of Related Art

As the mass has increasingly quickened their pace in the society, great intangible pressure is accumulated day by day, so most of people feel excessively psychological pressure and thus gradually turn to poor health. Therefore, people hope to express their mood through the interaction with a doll or through the doll itself, thereby partially relieving the psychological pressure. Although there are numerous dolls available in the current market, the dolls cannot fully express people's feelings, for example, sometimes the facial expression is too stiff, and sometimes the expression styles are not abundant enough.

Referring to FIG. 1, U.S. Pat. No. 7,234,989B2 has disclosed an eyelid-moving mechanism 10 of a doll, which is mainly characterized in that two eyeballs 11 and a lever 12 are connected together to form a center, and then the center is connected to shells 13 around the eyeballs 11, so that the eyelids 14 may move up and down around the center and then the motions of opening eyes, closing eyes may be achieved. However, in the prior art, it cannot drive only one eyelid to make the opening and closing motions, and the eyelids can do nothing but only opening and closing the eyes, and cannot rotate towards different angles to have more expressions as well. Therefore, it becomes more necessary to design a doll that is lively and has diversified expressions.

### SUMMARY OF THE INVENTION

In view of the above, the present invention is directed to a drive structure capable of driving two eyelids of a doll to make opening and closing motions at any angle independently, and also driving the eyelids to rotate at any angle.

In order to solve the above problem, the technical means provided by the present invention is to provide a curved surface actuating mechanism, capable of making moving or rotating motions. The actuating mechanism includes: a main shaft; a first drive unit, having a first drive wheel fitted on the main shaft and independently rotating on the main shaft and a first driving member; a second drive unit, having a second drive wheel fitted on the main shaft and independently rotating on the main shaft and a second driving member for driving the second drive wheel; a sleeve, fitted on the main shaft between the first drive wheel and the second drive wheel, independently rotating on the main shaft, and having a vertical split shaft; a third drive unit, having a third drive wheel fitted on the vertical split shaft and engaged with the first drive wheel and the second drive wheel at the same time; a curved surface having a link lever fixed to the third drive wheel. Therefore, if the first drive wheel and the second drive wheel rotate at the same time in the same direction, the third drive wheel is restrained by the first drive wheel and the second drive wheel to make the gear set operations along the axle center of the first drive wheel and the second drive wheel, thereby achieving the motions of opening or closing the curved surface (i.e., the eyelids of the doll). In order to rotate the curved surface in situ, the first drive wheel and the second drive wheel are made to rotate at the same time in opposite directions, such that the third drive wheel rotates around its own axial line and then drives the curved surface to rotate by a certain angle.

In order to solve the above problem, another technical means provided by the present invention is to provide a curved surface actuating mechanism, capable of making moving or rotating motions. The actuating mechanism includes a first drive unit, a second drive unit, a third drive unit, and a curved surface of an upper eyelid. The first drive unit has a first drive wheel and a first driving member. The second drive unit has a second drive wheel and a second driving member. The second drive wheel is co-axial with the first drive wheel. The third drive unit has a pair of third drive wheels serially connected by a shaft lever. The third drive wheel is engaged with the first drive wheel and the second drive wheel at the same time. The curved surface is fixed to the third drive wheel by using the link lever. Therefore, if the first drive wheel and the second drive wheel rotate at the same time in the same direction, the third drive wheel is restrained by the first drive wheel and the second drive wheel to rotate along the axle center of the first drive wheel and the second drive wheel, thereby making motions of opening or closing the curved surface. In order to rotate the curved surface in situ, the first drive wheel and the second drive wheel are made to rotate at the same time in opposite directions, such that the third drive wheel rotates around its own axial line and then drives the curved surface to rotate at a certain angle.

In the present invention, the first drive wheel, the second drive wheel, and the third drive wheel may all be gears or friction wheels. The third drive unit may operate around the axle center of the first drive wheel and the second drive wheel to form a gear set.

The efficacies achieved by the present invention lie in that, in the eyelid structure of the present invention, the eyes are moved independently, and the left and right eyes of the doll are respectively designed as an independent set, i.e., the motions of one eye may be controlled independently. Furthermore, the eyelid structure of the present invention has a two-dimensional orientation, which is capable of controlling complicated moving and rotating motions precisely and accurately, thereby enhancing the interpretive ability of the expressions of the doll.

In order to make the aforementioned and other objects, features and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of an eyelid-moving mechanism of a doll in the prior art.

FIG. 2 is an exploded perspective view of a curved surface actuating mechanism according to one embodiment of the present invention.

FIG. 3 is a combined perspective view of FIG. 2.

FIG. 4A is a schematic view of a rotating motion of a third drive wheel for the curved surface actuating mechanism according to an embodiment of the present invention.

FIG. 4B is a schematic view of a moving motion of the third drive wheel for the curved surface actuating mechanism according to an embodiment of the present invention.

FIG. 5 is a schematic plan view of a friction wheel for the curved surface actuating mechanism according to an embodiment of the present invention.

FIG. 6 is a schematic plan view of the curved surface actuating mechanism without a sleeve according to an embodiment of the present invention.

FIG. 7 is a schematic perspective view of a combined embodiment of a core actuating mechanism and a frame actuating mechanism wrapped from the periphery for the curved surface according to an embodiment of the present invention.

FIG. 8 is a schematic perspective view of FIG. 7 seen from another view angle.

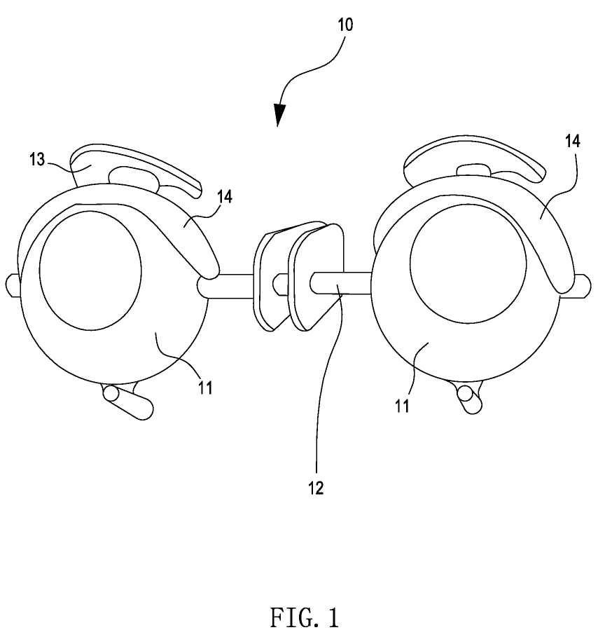

### DESCRIPTION OF EMBODIMENTS

The preferred embodiments of the present invention are illustrated below with reference to the accompanied drawings.

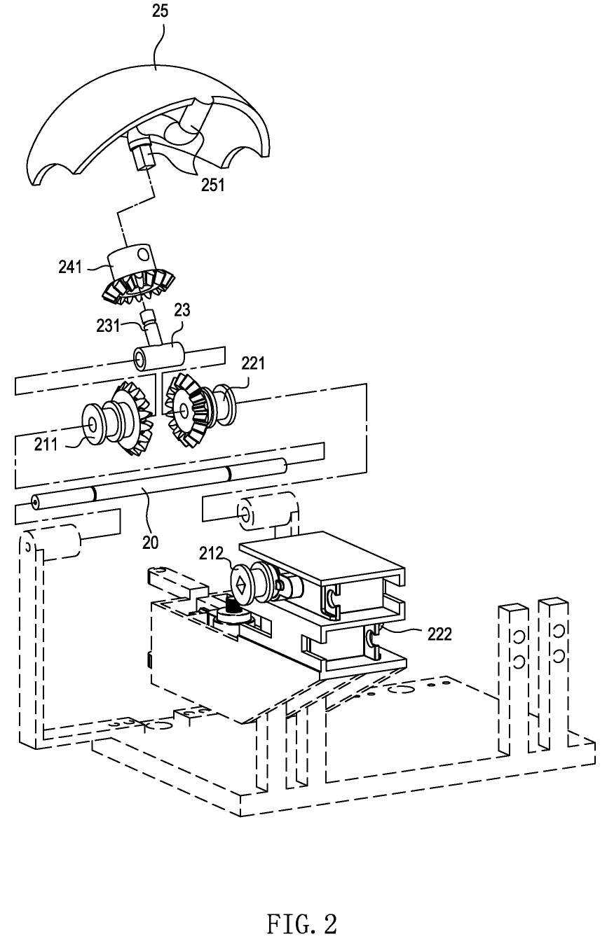

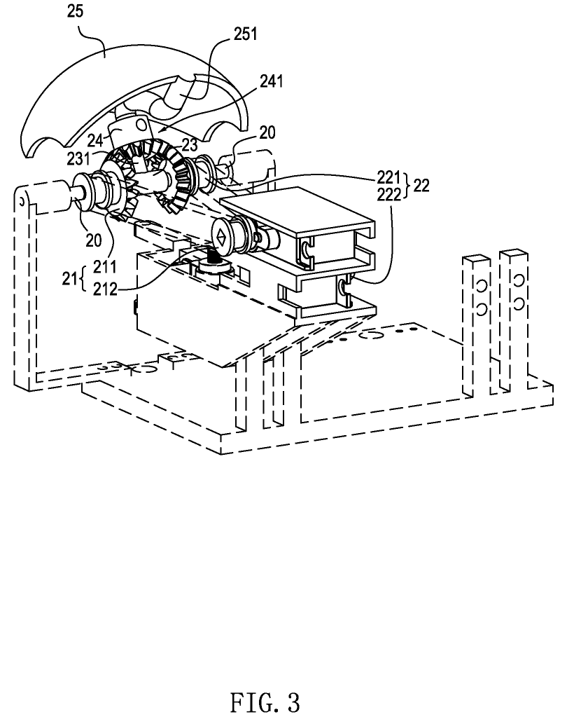

Referring to FIGS. 2 and 3, the curved surface actuating mechanism according to an embodiment of the present invention includes: a fixed main shaft 20; a first drive unit 21, having a first drive wheel 211 with conical teeth and a first driving member 212 for driving the first drive wheel 211, in which the first driving member 212 is generally a stepping motor and connected to the first drive wheel 211 by a timing belt (of course, the first driving member 212 may also be connected to the first drive wheel 211 by a gear set, besides the timing belt), and the first drive wheel 211 is fitted on one end of the main shaft 20 and independently rotates on the main shaft 20; a second drive unit 22, having a second drive wheel 221 and a second driving member 222 for driving the second drive wheel 221, in which the second drive wheel 221 has conical teeth, the second driving member 222 is a motor and connected to the second drive wheel 221 by a timing belt (the second driving member 222 may also be connected to the second drive wheel 221 by a gear set, besides the timing belt), and the second drive wheel 221 is fitted on the other end of the main shaft 20 and independently rotates on the main shaft 20; a sleeve 23, fitted on the main shaft 20 between the first drive wheel 211 and the second drive wheel 221 and independently rotating on the main shaft 20, in which the sleeve 23 is extended to form a vertical split shaft 231; a third drive unit 24, having a third drive wheel 241 with conical teeth, in which the third drive wheel 241 is engaged with the first drive wheel 211 and the second drive wheel 221 at the same time, and fitted on the vertical split shaft 231 of the sleeve 23; and a curved surface 25, having a link lever 251 fixed to the third drive wheel 241.

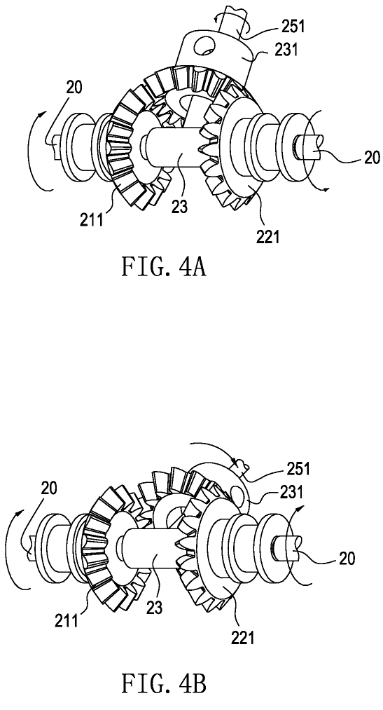

Referring to FIG. 4A, in the structure of the aforementioned embodiment, the curved surface 25 is generated used for simulating the shape of an eyelid for a doll. In this embodiment, a fixed main shaft 20 penetrates the first drive wheel 211 of the first drive unit 21, the sleeve 23, and the second drive wheel 221 of the second drive unit 22. The vertical split shaft 231 of the sleeve 23 is fitted on the third drive wheel 241, so that the first drive wheel 211, the third drive wheel 241, and the second drive wheel 221 form a gear set. When the first driving member 212 drives the first drive wheel 211 to rotate by using the timing belt (or gear set), and the second driving member 222 drives the second drive wheel 221 to rotate in the same direction as the first drive wheel 211 by using another timing belt (or gear set), the first drive wheel 211 and the second drive wheel 221 restrain the third drive wheel 241, so that the third drive wheel 241 cannot rotate around its own axial line, but rotate around the axle center of the first drive wheel 211 and the second drive wheel 221 upon being driven by the first drive wheel 211 and the second drive wheel 221 as a whole. Therefore, the curved surface 25 connected to the third drive wheel 241 may also move along the same axle center, thereby achieving the motions of opening and closing an eyelid, i.e., driving an eyelid to move up and down.

Referring to FIG. 4B, in addition, when the first drive wheel 211 and the second drive wheel 221 rotate in opposite directions, the restrained third drive wheel 241 rotates around its own axial line in situ. Therefore, the curved surface 25 connected to the third drive wheel 241 also rotates around its own axial line in situ, and thus, such a motion may simulate a tilt angle formed by the eyelid when an eyebrow is raised upwards or lowered downwards, i.e., driving the eyelid to move left and right.

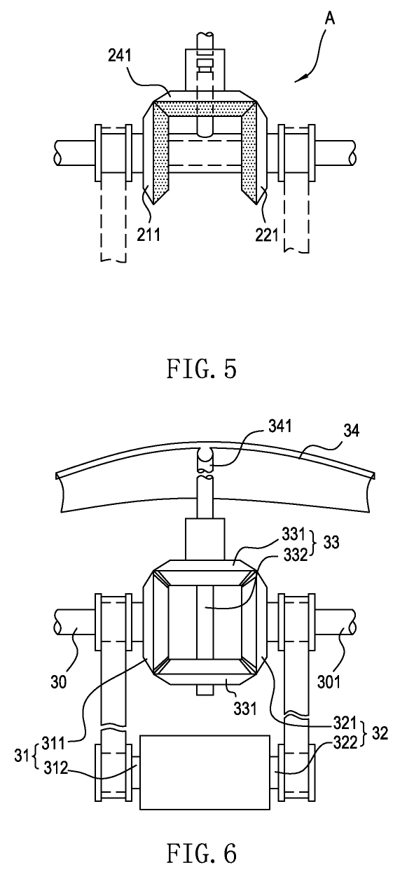

Referring to FIG. 5, in the aforementioned embodiment, the first drive wheel 211, the second drive wheel 221, and the third drive wheel 241 may also be friction wheels instead of gears, so as to form a friction wheel set A.

Furthermore, referring to FIG. 6, the curved surface actuating mechanism according to another embodiment of the present invention includes: a first shaft 30; a first drive unit 31, having a first drive wheel 311 pivoted to the first shaft 30 and a first driving member 312 for driving the first drive wheel 311 to rotate; a second shaft 301, being co-axial with the first shaft 30; a second drive unit 32, having a second drive wheel 321 pivoted to the second shaft 301 and a second driving member 322 for driving the second drive wheel 321 to rotate; a third drive unit 33, having a pair of third drive wheels 331 serially connected by a shaft lever 332 and engaged with the first drive wheel 311 and the second drive wheel 321 at the same time; and a curved surface 34, having a link lever 341 fixed to the third drive wheel 331 and interlocked with the third drive wheel 331. The first driving member 312 and the second driving member 322 are connected to the first drive wheel 311 and the second drive wheel 321 through using a motor and a belt (or gear) respectively, so as to offer a driving source.

In the structure of the aforementioned embodiment, the first drive wheel 311 is pivoted to the fixed first shaft 30, the second drive wheel 321 is pivoted to the fixed second shaft 301, and the pair of third drive wheels 331 are engaged with the first drive wheel 311 and the second drive wheel 321 up and down, so as to form a gear set. When the first drive wheel 211 and the second drive wheel 221 rotate in the same direction, the first drive wheel 311 and the second drive wheel 321 restrain the third drive wheel 331, so that the third drive wheel 331 cannot rotate around its own axial line, but rotate around the axle center of the first shaft 30 and the second shaft 301 as a whole. Therefore, the curved surface 34 connected to the third drive wheel 331 also moves and rotates around the same axle center, thereby achieving the motions of opening and closing an eyelid. In addition, when the first drive wheel 311 and the second drive wheel 321 rotate in opposite directions, the restrained third drive wheel 331 rotates around its own axial line in situ.

Therefore, the curved surface 34 connected to the third drive wheel 331 also rotates around its own axial line in situ, and thus, such a motion may simulate a tilt angle formed by the eyelid when an eyebrow is raised upwards or lowered downwards.

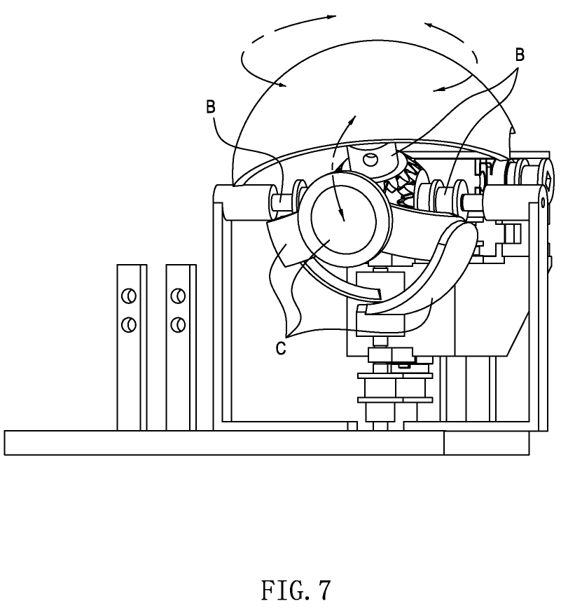

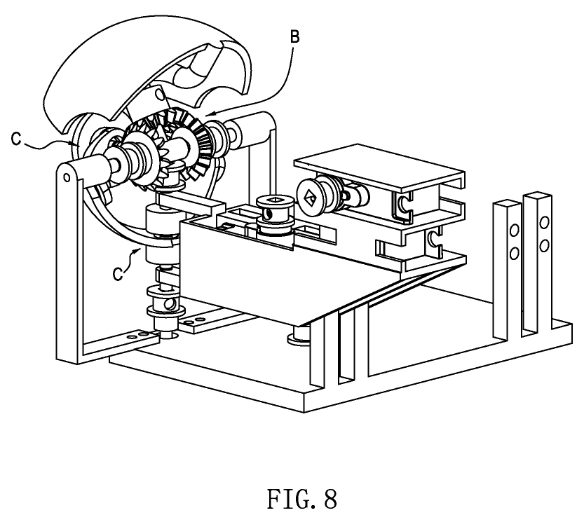

As shown in FIGS. 7 and 8, the embodiment in the present invention not only may be used in the eyelids of a doll (only one is shown in the figures) in pairs, but may also be used in the actuating mechanisms of other applications, such as astronomical telescopes, video cameras. When being applied in the doll, the overall volume and the volume during the actuating process need be controlled. The actuating mechanism provided by the present invention is directed to the part of “eyelids” and mainly mounted in a core position, which may be considered as a core actuating mechanism B. Then, this actuating mechanism may be flexibly used together with a frame actuating mechanism C directed to the part of “eyeballs” disposed at the periphery thereof, so as to make full use of all the spaces of the core and the periphery, thereby forming a combination mechanism of an eyelid and an eyeball occupying the minimum space, and achieving a variety of eye expressions.

Each of the aforementioned embodiments of the present invention may be mounted in an eye region of a doll, and in each eye, the eyelid is formed by the curved surface controlled by the curved surface actuating mechanism, and then the motions of the eyelid is controlled thereby.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A curved surface actuating mechanism, comprising:
a main shaft;
a first drive unit, having a first drive wheel and a first driving member for driving the first drive wheel to rotate, wherein the first drive wheel is fitted on one end of the main shaft and independently rotates on the main shaft;
a second drive unit, having a second drive wheel and a second driving member for driving the second drive wheel to rotate, wherein the second drive wheel is fitted on other end of the main shaft and independently rotates on the main shaft;
a sleeve, fitted on the main shaft between the first drive wheel and the second drive wheel and independently rotating on the main shaft, wherein the sleeve has a vertical split shaft;
a third drive unit, having a third drive wheel engaged with the first drive wheel and the second drive wheel at same time and fitted on the vertical split shaft of the sleeve, so that the third drive unit operates around the first drive wheel and the second drive wheel to form a gear set; and
a curved surface, having a link lever fixed to the third drive wheel.

2. The curved surface actuating mechanism as claimed in claim 1, wherein the first drive wheel, the second drive wheel, and the third drive wheel are gears.

3. The curved surface actuating mechanism as claimed in claim 1, wherein the first drive wheel, the second drive wheel, and the third drive wheel are friction wheels.

4. The curved surface actuating mechanism as claimed in claim 1, wherein the first driving member is a motor and a belt set for being connected to the first drive wheel and driving the first drive wheel.

5. The curved surface actuating mechanism as claimed in claim 1, wherein the first driving member is a stepping motor and a gear set for being connected to the first drive wheel and driving the first drive wheel.

6. The curved surface actuating mechanism as claimed in claim 1, wherein the second driving member is a stepping motor and a timing belt set for being connected to the second drive wheel and driving the second drive wheel.

7. The curved surface actuating mechanism as claimed in claim 1, wherein the second driving member is a stepping motor and a gear set for being connected to the second drive wheel and driving the second drive wheel.

8. The curved surface actuating mechanism as claimed in claim 1, wherein when the first drive wheel and the second drive wheel rotate in a same direction, the curved surface on the third drive wheel is driven to move up and down.

9. The curved surface actuating mechanism as claimed in claim 1, wherein when the first drive wheel and the second drive wheel rotate in opposite directions, the curved surface on the third drive wheel is driven to move left and right.

10. A doll, comprising:
an eye region;
a curved surface actuating mechanism, disposed within the eye region, and comprising: a main shaft, a first drive unit having a first drive wheel mounted on the main shaft, a second drive unit having a second drive wheel mounted on the main shaft, a sleeve mounted on the main shaft, a third drive unit having a third drive wheel mounted on the sleeve and forming a gear set together with the first drive wheel and the second drive wheel, and a curved surface connected to the third drive wheel.

11. A curved surface actuating mechanism, comprising:
a first shaft;
a first drive unit, having a first drive wheel pivoted to the first shaft and a first driving member for driving the first drive wheel to rotate;
a second shaft, being co-axial with the first shaft;
a second drive unit, having a second drive wheel pivoted to the second shaft and a second driving member for driving the second drive wheel to rotate;
a third drive unit, having a pair of third drive wheels, wherein the pair of third drive wheels are serially connected by a shaft lever and engaged with the first drive wheel and the second drive wheel at same time, so that the third drive unit operates around the first drive wheel and the second drive wheel to form a gear set; and
a curved surface, having a link lever fixed to the third drive wheel.

12. The curved surface actuating mechanism as claimed in claim 11, wherein the first drive wheel, the second drive wheel, and the third drive wheel are gears.

13. The curved surface actuating mechanism as claimed in claim 11, wherein the first drive wheel, the second drive wheel, and the third drive wheels are friction wheels, and the third drive unit operates around the first drive wheel and the second drive wheel to form a friction wheel set.

14. The curved surface actuating mechanism as claimed in claim 11, wherein the first driving member is a motor and a belt set for being connected to the first drive wheel and driving the first drive wheel.

15. The curved surface actuating mechanism as claimed in claim 11, wherein the first driving member is a motor and a gear set for being connected to the first drive wheel and driving the first drive wheel.

16. The curved surface actuating mechanism as claimed in claim 11, wherein the second driving member is a motor and a belt set for being connected to the second drive wheel and driving the second drive wheel.

17. The curved surface actuating mechanism as claimed in claim 11, wherein the second driving member is a motor and a gear set for being connected to the second drive wheel and driving the second drive wheel.

18. The curved surface actuating mechanism as claimed in claim 11, wherein when the first drive wheel and the second drive wheel rotate in a same direction, the curved surface on the third drive wheel is driven to move up and down.

19. The curved surface actuating mechanism as claimed in claim 11, wherein when the first drive wheel and the second drive wheel rotate in opposite directions, the curved surface on the third drive wheel is driven to move left and right.

20. A doll, comprising:
an eye region;
a curved surface actuating mechanism, disposed within the eye region, and comprising: a first shaft, a second shaft, a first drive unit having a first drive wheel mounted on the first shaft, a second drive unit having a second drive wheel mounted on the second shaft, a third drive unit having a pair of third drive wheels snapped with the first drive wheel and the second drive wheel up and down to form a gear set, and a curved surface connected to the third drive wheel.
